(19) United States
(12) Patent Application Publication
(10) Pub. No.: US 2002/0154887 A1
(43) Pub. Date: Oct. 24, 2002

(54) System and method for storing digital broadcast data

(75) Inventor: Jin Lu, Croton-on-Hudson, NY (US)

Correspondence Address: Michael E. Marion, Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/840,209

(22) Filed: Apr. 23, 2001

(51) Int. Cl. H04N 9/79; H04N 7/16

(52) U.S. Cl. 386/35; 725/135

(57) ABSTRACT

There is disclosed a data storage apparatus for downloading data from datacast streams transmitted by a television broadcast system to a plurality of similar data storage apparatuses. The data storage apparatus comprises: 1) a storage medium for storing selected portions of the transmitted datacast streams; and 2) a content filtering processor for receiving a first datacast stream transmitted by the television broadcast system and detecting therein a plurality of datacast blocks, wherein the content filtering processor compares a first content parameter associated with a first one of the datacast blocks with at least one subscriber-specific parameter associated with the data storage apparatus and wherein the content filtering processor, in response to a determination that the first content parameter matches the at least one subscriber-specific parameter, stores the first datacast block in the storage medium.

### TECHNICAL FIELD OF THE INVENTION

The present invention is directed, in general, to broadcasting systems and, more specifically, to a system and method for storing broadcasted text, web page, and other data on disk-based video storage devices.

### BACKGROUND OF THE INVENTION

The popularity of the Internet has made web browsing a common everyday event to millions of people. For many of these people, web browsing is no mere diversion. It is an essential activity in their private or professional lives. Many people rely on Internet access as their primary source of news and weather reports. Also, many people read about news and recent developments in their chosen profession from information web sites related to their line of business.

However, due to the relative slowness of Internet access, all of this web browsing activity can result in a tremendous amount of lost time. The lost time usually comes in the form of waiting for web page data to download. The slowness often is caused by a modem connection (e.g., 28.8 or 56 Kbps) used by the person. However, even faster connections, such as cable modem and DSL, have limited bandwidth during periods of peak usage. Moreover, if the web site that a person is accessing is heavily visited, such as MSN.com, or Yahoo.com, or Amazon.com, bottlenecks at the web site will cause slow download speeds regardless of the connection speed of the user.

Another drawback to the Internet experience is the reliance on personal computers for Internet access. Personal computers are relatively expensive devices. As a result, many people can browse the Internet only when they are at work. Furthermore, a person may prefer to browse the Internet from the comfort of his or her living room. This frequently is more relaxing than sitting at a computer at a desk in a home office.

There is therefore a need for improved methods and systems for retrieving and viewing web page data from the Internet, particularly from popular web sites. In particular, there is a need for alternative systems for pre-downloading web site data for subsequent viewing by a person. More particularly, there is a need for consumer devices other than personal computers that are capable of accessing web page data easily and rapidly.

### SUMMARY OF THE INVENTION

To address the above-discussed deficiencies of the prior art, it is a primary object of the present invention to provide a broadcast system for broadcasting predetermined blocks of data to subscribers and to provide video playback devices capable of storing selected portions of the predetermined blocks of data according to the preferences of the subscribers. In this disclosure, the term “subscriber” means any person (i.e., consumer or viewer) who receives and stores data from the broadcast facility, whether or not that person actually is subscribing to a paid service.

Data broadcasting (or datacasting) is a cost-effective way to deliver high-throughput data to millions of consumers over digital television (TV) broadcast systems. The broadcast data may contain text data, such as news articles, music files, web page data, weather reports, stock ticker data, electronic books (i.e., e-books), local advertisements, and other non-video data files, to mention a few. Because of the high data throughput, information arrives in real time. With datacasting, the broadcast data is streamed to millions of homes along with conventional digital television programming signals. The data throughput can go as high as 19 million bits per second (Mbps) for every 6 MHz-channel (more data throughput for 8 MHz-channels). A single datacasting transmission station can cover an area up to 80 kilometers (km) in radius.

Generally speaking, a small percentage (e.g., 20%) of the broadcast bandwidth may be devoted to datacasting during the day. At night, when few people view television programming, more broadcast bandwidth can be devoted to delivering all kinds of large data files to consumers. To give an idea of how much data can be delivered using data broadcast, consider the situation in which fifty conventional television channels are used as datacasting channels during the period between 1:00 AM and 5:00 AM. The amount of data the 50 channels combined can send is:

(19 Mbits/sec.)(3600 sec./hr.)(4 hr.)(50)=13,680 Gbits

The foregoing example assumes a terrestrial broadcast that delivers about 19 Mbps per 6 MHz channel. The data throughput is higher if we consider data broadcasts over cable television systems. The amount of data that can be delivered overnight is roughly 14 trillion bits.

A situation is now considered in which a local broadcaster in Westchester, N.Y., uses its bandwidth to broadcast data to the approximately 224,480 households in Westchester. On average, each household receives:

13,680 Gbits/224,480 households=60 Mbits/household

In other word, every Westchester household could get roughly 60 Mbits from a single local broadcaster. If a household uses a 28 Kbps dial-up modem to download the same amount of data, it takes 60 Kbits/14 Kbps=4200 seconds (more than 1 hour) to complete the download, assuming the average dial-up data rate is 14 Kbps, half of the maximum speed. One hour of dial-up downloading amounts to two or three hours of online time, assuming that a person does the downloading half the time and does the reading half the time.

However, the average household spends less than two hours a day on-line. If broadcasters know what Internet sites an individual consumer prefers, the broadcaster can broadcast each night the web pages preferred by each consumer. When the consumer goes online the next day, the information is there instantly.

While broadcasters have no way to know exactly what web sites people prefer, the broadcasters can make certain assumptions. The broadcasters can use Internet surfing statistics to figure out the most popular web sites, and the geographic patterns of consumer web surfing. To understand the later point, during the 2000 Subway Series, the residents living on the East Coast, particularly in New York, were more likely to go to web sites devoted to the World Series than the rest of the country, since the series involve the two teams in New York City. Assuming broadcasters do a good job figuring out the web surfing patterns and broadcast the web content accordingly, the broadcast web pages can cover a good percentage of the interests of all web surfers.

It is a primary object of the present invention to provide a data storage apparatus for downloading data from datacast streams transmitted by a television broadcast system to a plurality of similar data storage apparatuses. According to an advantageous embodiment of the present invention, the data storage apparatus comprising: 1) a storage medium for storing selected portions of the transmitted datacast streams; and 2) a content filtering processor capable of receiving a first datacast stream transmitted by the television broadcast system and detecting therein a plurality of datacast blocks, wherein the content filtering processor compares a first content parameter associated with a first one of the datacast blocks with at least one subscriber-specific parameter associated with the data storage apparatus and wherein the content filtering processor, in response to a determination that the first content parameter matches the at least one subscriber-specific parameter, stores the first datacast block in the storage medium.

According to one embodiment of the present invention, the first datacast block comprises a broadcast block receivable by each of the plurality of similar data storage apparatuses.

According to another embodiment of the present invention, the first datacast block comprises a multicast block receivable by a sub-group of the plurality of similar data storage apparatuses.

According to still another embodiment of the present invention, the first content parameter comprises a multicast group identifier associated with the data storage apparatus.

According to yet another embodiment of the present invention, the first datacast block comprises a unicast block receivable only by the data storage apparatus.

According to a further embodiment of the present invention, the first content parameter comprises a unique address associated with the data storage apparatus.

According to a still further embodiment of the present invention, the first datacast stream comprises webpage data.

According to a yet further embodiment of the present invention, the first datacast stream comprises Internet protocol (IP) data.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, which execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary television broadcast system according to one embodiment of the present invention;

FIG. 2 illustrates an exemplary video playback device and television set according to one embodiment of the present invention;

FIG. 3 illustrates an exemplary frame of broadcast data, multicast data, and unicast data according to one embodiment of the present invention;

FIG. 4 illustrates an exemplary video playback device in greater detail according to one embodiment of the present invention; and

FIG. 5 is a flow diagram illustrating the operation of the exemplary video playback device according to one embodiment of the present invention.

### DETAILED DESCRIPTION OF THE INVENTION

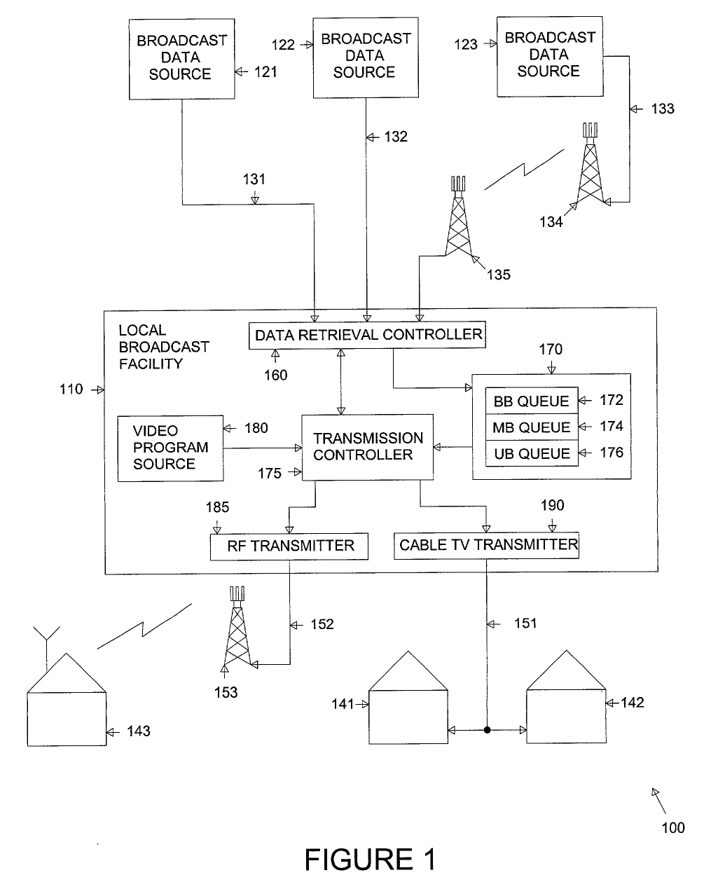

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged digital broadcast system and video playback device.

FIG. 1 illustrates exemplary television broadcast system 100 according to one embodiment of the present invention. Television broadcast system 100 comprises local broadcast facility 110, which receives one or more data streams from each of broadcast data sources 121-123. Local broadcast facility 110 may receive these data streams from wireline communication links (including Internet connections) or from wireless communication links. For example, local broadcast facility 110 receives one or more data streams from broadcast data source 121 via wireline communication link 131 and receives one or more data streams from broadcast data source 122 via wireline communication link 132. Broadcast data sources 121-123 may include any type of data that may be viewed by a user on a television or a personal computer. Thus, broadcast data sources 121-123 may include websites that provide political news, entertainment news, financial data, stock tickers, sport scores, and the like.

Local broadcast facility 110 also comprises base transceiver stations 134 and 135, which wirelessly transmit one or more data streams from broadcast data source 123 to local broadcast facility 110. In an exemplary embodiment, broadcast data source 123 may transmit the data streams via communication line 133 to base transceiver station 134, which is part of a local multipoint distribution system (LMDS) network. In an LMDS network, a microwave link is used to transmit the data stream from base transceiver station 134 to base transceiver station 135.

Local broadcast facility 110 transmits broadcast data, multicast data, and unicast data to subscriber locations 141-143, which may include both private residences and business locations. If local broadcast facility 110 is part of a cable television system, local broadcast facility 110 may transmit broadcast data, multicast data, and unicast data to subscriber locations 141 and 142 via communication wireline 151. Communication wireline 152 carries one or more outbound broadcast, multicast, and unicast data streams from local broadcast facility 110 to transmitter 153, which wirelessly transmits the outbound data streams to subscriber location 143. Each of the broadcast data, multicast data, and unicast data streams transmitted by local broadcast facility may be carried in, for example, a 6 MHz broadcast television channel.

Local broadcast facility 110 transmits data of general interest to all subscribers in broadcast data streams that may be received and stored by the video playback devices used by all subscribers that receive wireless broadcasts or cable broadcasts from local broadcast-facility 110. Local broadcast facility 110 transmits multicast data streams to selected subscribers who form multicast groups. The multicast data streams may be received and stored by the video playback devices of the multicast group subscribers. Special address or other identification data are embedded in each multicast data stream to allow the video playback devices to capture and store the correct multicast data streams. The video playback devices of subscribers who are not part of a particular multicast group ignore the corresponding multicast data stream.

Finally, local broadcast facility 110 transmits unicast data streams to individual subscribers. Each subscriber has a unique address or other identification data that allows the subscriber's video playback device to capture and to store the correct unicast data stream. There are a number of ways in which a subscriber may inform local broadcast facility 110 of the particular data content that the subscriber wishes to receive in a unicast data stream. One particularly useful method is for the subscriber to access a website operated by local broadcast facility 110 for the specific purpose of receiving subscriber selection and preference information. The subscriber provides the web site with the subscriber's unique address or other identification data and enters a list of web pages, stock ticker streams, and the like that the subscriber wishes to receive.

Local broadcast facility 110 comprises data retrieval controller 160, memory 170, transmission controller 175, video program source 180, radio frequency (RF) transmitter 185, and cable television (TV) transmitter 190. Memory 170 contains broadcast block (BB) queue 172, multicast block (MB) queue 174, and unicast block (UB) queue 176. Broadcast block queue 172 holds a block of assembled web page and other data that is to be broadcast to all subscribers. Multicast block queue 174 holds blocks of assembled web page and other data that are to be multicast to groups of subscribers. Finally, unicast block queue 176 contains blocks of assembled web page and other data that are to be transmitted to individual subscribers.

Transmission controller 180 directs the overall operation of local broadcast facility 110. During ordinary operations, transmission controller 175 retrieves conventional video programs (i.e., newscasts, sportscasts, comedies, dramas) from video programs source 180 and transfers the video programs to RF transmitter 185 and/or cable TV transmitter 190 for subsequent wireless transmission or cable transmission to subscriber locations 141-143. Transmission controller 180 also controls the transmission of datacasts during selected times of day, such as at night between 1:00 AM and 5:00 AM. Transmission controller 180 receives and stores user preference information and determines the sizes and the contents of broadcast block queue 172, multicast block queue 174, and unicast block queue 176.

Under the control of transmission controller 175, data retrieval controller 160 periodically (e.g., hourly, daily, twice per day, and the like) retrieves data from broadcast data sources 121-123 and stores the data in appropriate ones of broadcast block queue 172, multicast block queue 174, and unicast block queue 176. At the designated times (e.g., between 1:00 AM and 5:00 AM) transmission controller 175 terminates the transmission of conventional video programs in one or more of the 6 MHz television channels operated by local broadcast facility 110. Transmission controller 175 then begins retrieving the blocks of data from broadcast block queue 172, multicast block queue 174, and unicast block queue 176 and transfers the blocks of data to RF transmitter 185 and/or cable TV transmitter 190 for subsequent wireless transmission or cable transmission to subscriber locations 141-143.

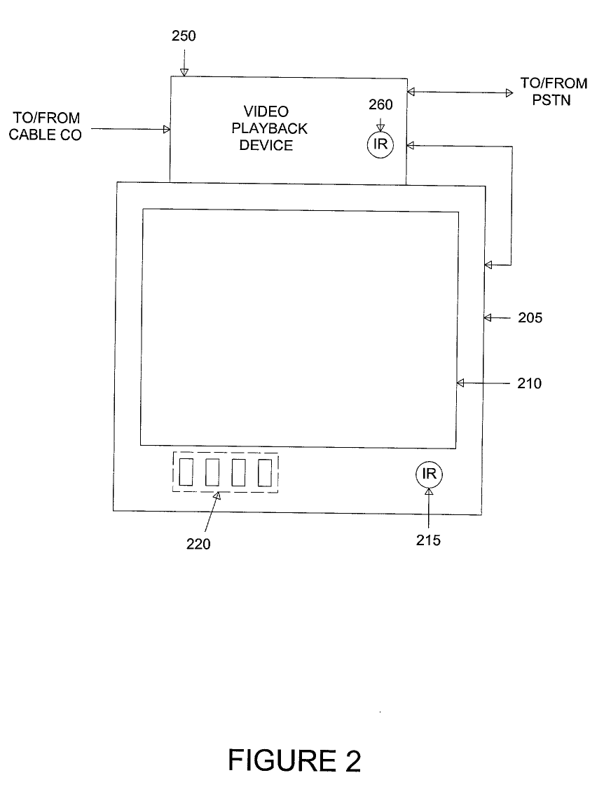

FIG. 2 illustrates exemplary video playback device 250 and television set 205 according to one embodiment of the present invention. Video playback device 250 receives incoming television signals from an external source, such as a cable television service provider (Cable Co.), a satellite dish, or a local RF antenna, and transmits a viewer-selected channel to television set 205. In RECORD mode, video playback device 250 may demodulate an incoming radio frequency (RF) television signal to produce a baseband video signal that is recorded and stored on a storage medium within or connected to video playback device 250. In PLAY mode, video playback device 250 reads a stored baseband video signal (i.e., program) selected by the user from the storage medium and transmits it to television set 205.

Video playback device 250 is a disk drive-based device, such as a ReplayTV recorder or a TiVO recorder. Video playback device 250 stores and retrieves the incoming television signals to and from a computer magnetic hard disk rather than a magnetic cassette tape. In still other embodiments, video playback device 250 may store and retrieve from a local read/write (R/W) digital versatile disk (DVD) or R/W CD-ROM. Thus, the local storage medium may be fixed (i.e., hard disk drive) or removable (i.e., DVD, CD-ROM).

Video playback device 250 comprises infrared (IR) sensor 260 that receives commands (such as Channel Up, Channel Down, Volume Up, Volume Down, Record, Play, Fast Forward (FF), Reverse, and the like) from a remote control device operated by the subscriber. As will be explained in greater detail below, IR sensor 260 may also receive user commands from a keyboard and/or mouse operated by the subscriber that permits the subscriber to view web page data and other types of data that video playback device 250 captures from broadcast, multicast and unicast transmissions. Television set 205 is a conventional television comprising screen 210, infrared (IR) sensor 215, and one or more manual controls 220 (indicated by a dotted line). IR sensor 215 also receives commands (such as volume up, volume down, power ON/OFF) from a remote control device operated by the viewer.

It should be noted that video playback device 250 is not limited to receiving a particular type of incoming television signal from a particular type of source. As noted above, the external source may be a cable TV connection, a conventional RF broadcast antenna, or a satellite dish. The incoming signal may be a digital signal, an analog signal, or Internet protocol (IP) packets. However, for the purposes of simplicity and clarity in explaining the principles of the present invention, the descriptions that follow shall generally be directed to an embodiment in which video playback device 250 receives incoming television signals (analog and/or digital) from a cable service provider. Nonetheless, those skilled in the art will understand that the principles of the present invention may readily be adapted for use with wireless broadcast television signals, local storage systems, an incoming stream of IP packets containing MPEG data, and the like.

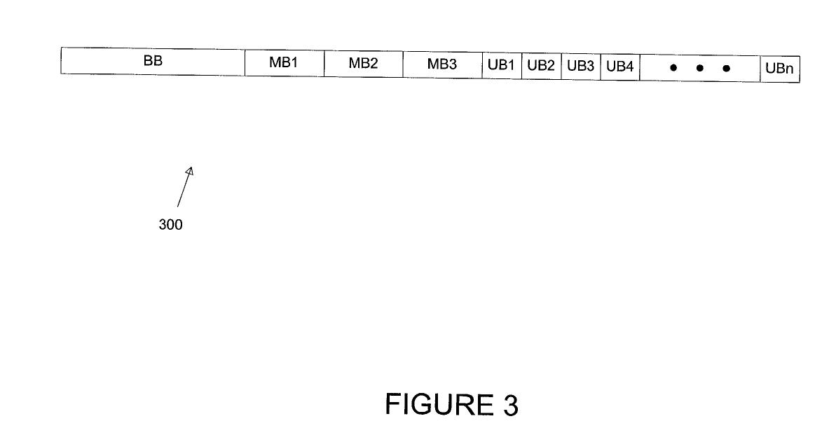

FIG. 3 illustrates exemplary datacast stream 300, which of broadcast data, multicast data, and unicast data, according to one embodiment of the present invention. Local broadcast facility 110 may transmit datacast streams similar to exemplary datacast stream 300 in up to M channels, according to the number of subscribers in the coverage area of local broadcast facility 110. Datacast stream 300 is transmitted in a single TV channel and may have a duration in the range of seconds to hours. Exemplary datacast stream 300 comprises a broadcast block (BB), three multicast blocks (MB1, MB2, and MB3), and N unicast blocks (UB1, UB2, UB3, UB4, . . . , UBn).

Broadcast data of general interest to all subscribers, such as web pages from eBay, Amazon, and Yahoo, are transmitted in the broadcast block. The broadcast block comprises a broadcast block (BB) header that contains a unique address of other identifier that identifies the broadcast block to the video playback devices used by subscribers. Data of interest to smaller numbers of subscribers are transmitted in MB1, MB2, and MB3. Each of MB1, MB2, and MB3 comprises a multicast block (MB) header that contains a unique address or other identifier that identifies MB1, MB2, and MB3 to the video playback devices used by subscribers. If a multicast block contains an address that matches the selection criteria used by a video playback device, the video playback captures and stores the multicast block. Otherwise, the video playback device ignores the multicast block. Multicast blocks may be tailored to any criteria. For example, MB1 may comprise web page data associated with the World Series during the week preceding the World Series. MB2 may comprise web page data associated with a particular ethnic group, such as a Spanish language newspaper articles.

Data of interest only to individual subscribers are transmitted in UB1 through UBn. Each of UB1 though UBn comprises a unicast block (UB) header that contains a unique address or other identifier that identifies each unicast block to the video playback devices used by subscribers. If a unicast block contains an address that matches the unique address associated with the video playback device of a particular subscriber, the video playback captures and stores the unicast block. Otherwise, the video playback device ignores the unicast block.

It is noted that the configuration and manner of transmission of exemplary datacast stream 300 may be modified in a number of ways. For example, there is no requirement that each datacast stream contain each type of data block. In one embodiment of the present invention, local broadcast facility 110 may transmit datacast streams containing only broadcast data blocks in a first set of TV channels, may transmit datacast streams containing only multicast data blocks in a second set of TV channels, and may transmit datacast streams containing only unicast data blocks in a third set of TV channels.

Alternatively, spatial diversity may be used to conserve broadcast spectrum. For example, selected multicast blocks may be broadcast in some areas, but not in others. For example, if transmitter 153 broadcasts in a Spanish-speaking area, local broadcast facility may transmit primarily multicast blocks containing Spanish language web data from transmitter 153. At the same time, different types of multicast blocks may be transmitted via cable system communication wireline 151 to subscriber locations 141 and 142.

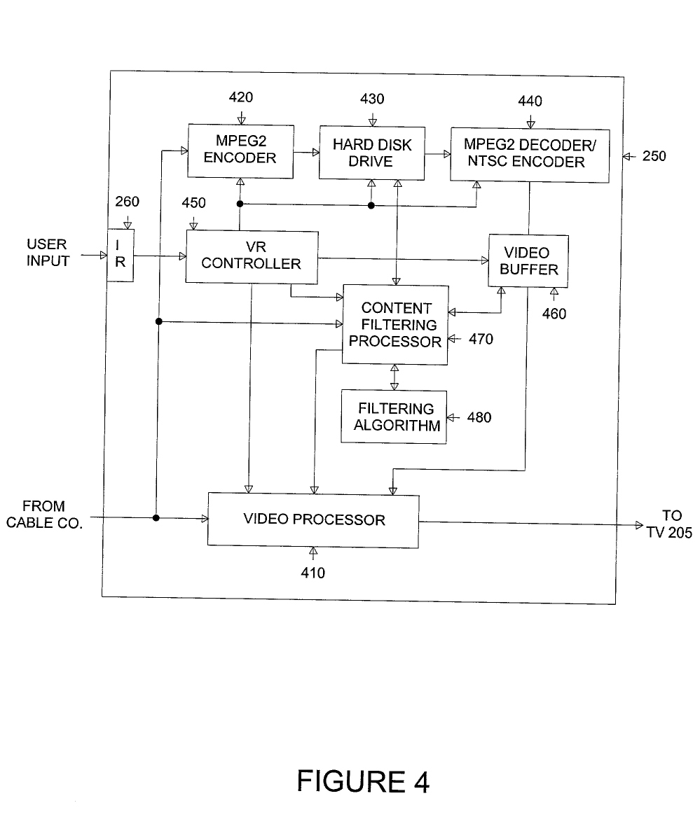

FIG. 4 illustrates exemplary video playback device 250 in greater detail according to one embodiment of the present invention. Video playback device 250 comprises IR sensor 260, video processor 410, MPEG2 encoder 420, hard disk drive 430, MPEG2 decoder/NTSC encoder 440, and video recorder (VR) controller 450. Video playback device 250 further comprises video buffer 460, content filtering processor 470, and filtering algorithm 480, which may be embodied as a memory that stores a filtering algorithm as a sequence of program instructions executed by content filtering processor 470. VR controller 450 directs the overall operation of video playback device 250, including View mode, Record mode, Play mode, Fast Forward (FF) mode, Reverse mode, among others.

In View mode, VR controller 450 causes the incoming television signal from the cable service provider to be demodulated and processed by video processor 410 and transmitted to television set 205, without storing or retrieving from hard disk drive 430. Video processor 410, which may be, for example, a TriMedia (TM) 1100 media processor, contains radio frequency (RF) front-end circuitry for receiving incoming television signals from the cable service provider, tuning to a user-selected channel, and converting the selected RF signal to a baseband television signal (e.g., super video signal) suitable for display on television set 205. Video processor 410 also is capable of receiving a conventional NTSC signal from MPEG2 decoder/NTSC encoder 440 (after buffering in video buffer 460) during Play mode and transmitting a baseband television signal (e.g., super video signal) to television set 205.

In Record mode, VR controller 450 causes the incoming television signal to be stored on hard disk drive 430. Under the control of VR controller 450, MPEG2 encoder 420 receives the incoming television signal from the cable service provider and converts the received RF signal to MPEG format for storage on hard disk drive 430. In Play mode, VR controller 450 directs hard disk drive 430 to stream the stored television signal (i.e., program) to MPEG2 decoder/NTSC encoder 440, which converts the MPEG2 data from hard disk drive 430 to, for example, a super video (S-Video) signal that is buffered in video buffer 460 before video processor 410 transmits it to television set 405.

It should be noted that the choice of the MPEG2 standard for MPEG2 encoder 420 and MPEG2 decoder/NTSC encoder 440 is by way of illustration only. In alternate embodiments of the present invention, the MPEG encoder and decoder may comply with one or more of the MPEG-1, MPEG-2, MPEG-4, and MPEG-7 standards.

For the purposes of this application and the claims that follow, hard disk drive 430 is defined to include any mass storage device that is both readable and writable, including conventional magnetic disk drives and optical disk drives for read/write digital versatile disks (DVD-RW), re-writable CD-ROMs, VCR tapes and the like. In fact, hard disk drive 430 need not be fixed in the conventional sense that is permanently embedded in video playback device 250. Rather, hard disk drive 430 includes any mass storage device that is dedicated to video playback device 250 for the purpose of storing recorded video programs or downloaded broadcast data, multicast data, or unicast data. Thus, hard disk drive 430 may include an attached peripheral drive or removable disk drives (whether embedded or attached), such as a jukebox device that holds read/write DVDs or re-writable CD-ROMs. Furthermore, in an advantageous embodiment of the present invention, hard disk drive 430 may include external mass storage devices that video playback device 250 may access and control via a network connection (e.g., Internet protocol (IP) connection), including, for example, a disk drive in the subscriber's home personal computer (PC) or a disk drive on a server at the subscriber's Internet service provider (ISP).

In accordance with the principles of the present invention, video playback device 250 also supports a Datacast mode in which broadcast data blocks, multicast data blocks, and unicast data blocks are monitored in a data cast stream, such as exemplary datacast stream 300, and are selectively captured and stored in hard disk drive 430 for later viewing by the subscriber. In Datacast mode, VR controller 450 causes content filtering processor 470 to monitor the incoming television signal and to store selected portions of the broadcast blocks, multicast blocks, and unicast blocks in the incoming television signal on hard disk drive 430. Under the control of VR controller 450, content filtering processor 470 receives the incoming television signal on predetermined datacast channels from the cable service provider and identifies the broadcast blocks, multicast blocks, and unicast blocks therein.

Content filtering processor 470 uses filtering algorithm 480 to decide what data to store from the broadcast blocks, multicast blocks, and unicast blocks. Filtering algorithm 480 uses a first pass filter to identify and capture the broadcast block, one or more multicast blocks that interest the subscriber, and the unicast blocks associated with the subscriber. Optionally, filtering algorithm 480 may then apply a second pass filter that analyzes the captured data from the broadcast block and identifies therein particular websites and subject matter of interest to the subscriber. Content filtering processor 470 may then store only data that passes the second pass filter in hard disk drive 430. The rest of the broadcast block data is discarded.

Similarly, filtering algorithm 480 may apply a third pass filter that analyzes the captured data from the one or more multicast blocks and identifies therein particular websites and subject matter of interest to the subscriber. Content filtering processor 470 may then store only data that passes the third pass filter in hard disk drive 430. The rest of the multicast block data is discarded.

VR controller 450 and content filtering processor 470 are capable of learning the preferences of the subscriber and deciding what content to retrieve from a datacast stream. Filtering algorithm 480 may be updated by content filtering processor 470 to include selection parameters that describe the types of data that interest the subscriber. The selection parameters can be set by the subscriber based on electronic programming guide (EPG) data that is received in a designated television channel. Alternatively, filtering algorithm may set the selection parameters according to the subscriber's history of data content viewing.

Normally, there are EPG data tables inside the data broadcast stream that inform the video playback devices of the types of data included in the stream. When the data broadcast stream is received by video playback device 250, content filtering processor 470 compares the EPG data to the preferences of the subscriber. If some types of data match the selection criteria of the subscriber, content filtering processor 470 captures the corresponding data and stores the captured data on hard disk drive 430.

According to the principles of the present invention, video playback device 250 also supports a Browse mode in which stored web page data and other data captured from broadcast blocks, multicast blocks, and unicast blocks are retrieved from hard disk drive 430 and displayed on TV 205. In Browse mode, VR controller 450 may execute an embedded browser application that retrieves stored web page data from hard disk drive 430 and transfers it to video buffer 460 for subsequent transfer to video processor 410. Video processor 410 then displays the web page data on television 205.

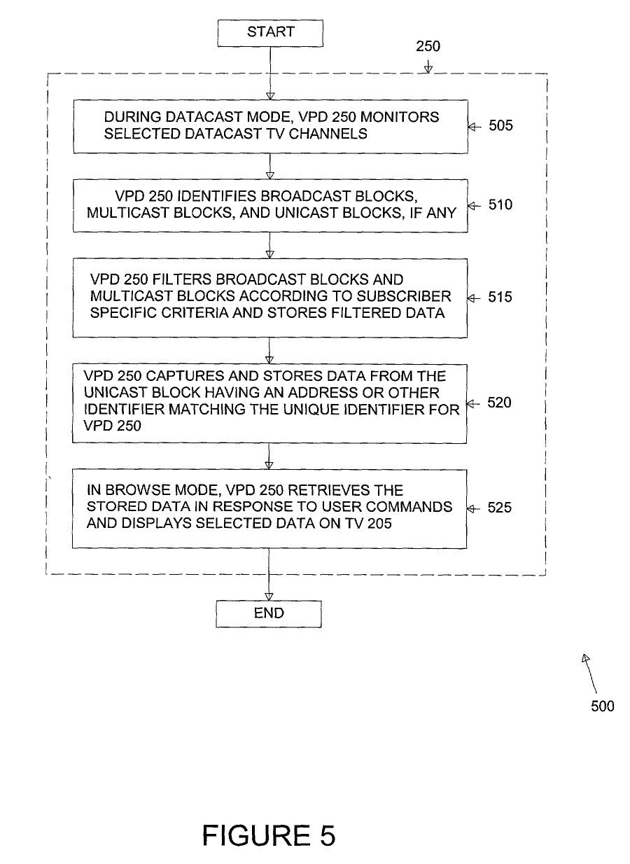

FIG. 5 depicts flow diagram 500, which illustrate the operation of the exemplary video playback device according to one embodiment of the present invention. During Datacast mode, video playback device 250 monitors selected datacast television channels (process step 505). Video playback device 250 identifies broadcast blocks, multicast blocks, and unicast blocks, if any (process step 510). Video playback device 250 filters broadcast blocks and multicast blocks according to subscriber specific criteria and stores the filtered data (process step 515). Video playback device 250 captures and stores data from the unicast block having an address or other identifier matching the unique identifier for video playback device 250 (process step 520). Finally, in Browse mode, video playback device 250 retrieves the stored data in response to user commands and displays selected data on television 205 (process step 525).

It should be understood that the exemplary video playback device described above is only one possible embodiment of the present invention. More generally, the present invention may be embodied as a stand-alone device that may be coupled to other devices, such as a personal computer. In such an embodiment, the television receiver portion and the MPEG encoding and decoding portions of video playback device 250 may be omitted.

Although the present invention has been described in detail, those skilled in the art should understand that they may make various changes, substitutions and alterations herein without departing from the spirit and scope of the invention in its broadest form.

What is claimed is:

1. A data storage apparatus for downloading data from datacast streams transmitted by a television broadcast system to a plurality of similar data storage apparatuses, said data storage apparatus comprising:
a storage medium for storing selected portions of said transmitted datacast streams; and
a content filtering processor capable of receiving a first datacast stream transmitted by said television broadcast system and detecting therein a plurality of datacast blocks, wherein said content filtering processor compares a first content parameter associated with a first one of said datacast blocks with at least one subscriber-specific parameter associated with said data storage apparatus and wherein said content filtering processor, in response to a determination that said first content parameter matches said at least one subscriber-specific parameter, stores said first datacast block in said storage medium.

2. The data storage apparatus as set forth in claim 1 wherein said first datacast block comprises a broadcast block receivable by each of said plurality of similar data storage apparatuses.

3. The data storage apparatus as set forth in claim 1 wherein said first datacast block comprises a multicast block receivable by a sub-group of said plurality of similar data storage apparatuses.

4. The data storage apparatus as set forth in claim 3 wherein said first content parameter comprises a multicast group identifier associated with said data storage apparatus.

5. The data storage apparatus as set forth in claim 1 wherein said first datacast block comprises a unicast block receivable only by said data storage apparatus.

6. The data storage apparatus as set forth in claim 5 wherein said first content parameter comprises a unique address associated with said data storage apparatus.

7. The data storage apparatus as set forth in claim 1 wherein said first datacast stream comprises webpage data.

8. The data storage apparatus as set forth in claim 1 wherein said first datacast stream comprises Internet protocol (IP) data.

9. A method for downloading data from datacast streams transmitted by a television broadcast system to a plurality of data storage apparatuses, the method comprising the steps of:
receiving a first datacast stream transmitted by the television broadcast system;
detecting in the first datacast stream a plurality of datacast blocks;
comparing a first content parameter associated with a first one of the datacast blocks with at least one subscriber-specific parameter associated with a first one of the data storage apparatuses; and
in response to a determination that the first content parameter matches the at least one subscriber-specific parameter, storing the first datacast block in a storage medium associated with the first data storage apparatus.

10. The method as set forth in claim 9 wherein the first datacast block comprises a broadcast block receivable by each of the plurality of data storage apparatuses.

11. The method as set forth in claim 9 wherein the first datacast block comprises a multicast block receivable by a sub-group of the plurality of similar data storage apparatuses.

12. The method as set forth in claim 11 wherein the first content parameter comprises a multicast group identifier associated with the data storage apparatus.

13. The method as set forth in claim 9 wherein the first datacast block comprises a unicast block receivable only by the data storage apparatus.

14. The method as set forth in claim 13 wherein the first content parameter comprises a unique address associated with the data storage apparatus.

15. The method as set forth in claim 9 wherein the first datacast stream comprises webpage data.

16. The method as set forth in claim 9 wherein the first datacast stream comprises Internet protocol (IP) data packets.

17. A television broadcasting system capable of transmitting datacast streams to a plurality of data storage apparatuses capable of capturing data in said datacast streams, said television broadcast system comprising:
a data retrieval controller capable of accessing a plurality of data sources and retrieving from each of said plurality of data sources web page data associated with said each of said plurality of data sources;
a memory for storing said retrieved web page data in a plurality of transmission queues; and
a transmission controller capable of causing a first of said plurality of transmission queues to be transmitted in a broadcast transmission receivable by all of said plurality of data storage apparatuses and further capable of causing a second of said plurality of transmission queues to be transmitted in a multicast transmission, wherein selected portions of web page data in said second transmission queue are receivable by only selected subgroups of said plurality of data storage apparatuses.

18. The television broadcasting system as set forth in claim 17 wherein said transmission controller is further capable of causing a third of said plurality of transmission queues to be transmitted in a unicast transmission, wherein selected portions of web page data in said third transmission queue are receivable only by individual ones of said plurality of data storage apparatuses.

19. The television broadcasting system as set forth in claim 18 wherein transmission controller causes said first, second and third transmission queues to be transmitted at predetermined times of the day.

20. The television broadcasting system as set forth in claim 18 wherein a first selected portion of web page data in said third transmission queue comprises a unique identifier associated with a first data storage apparatus capable of receiving said first selected portion of web page data in said third transmission queue.
